(19) United States
(12) Patent Application Publication
(10) Pub. No.: US 2014/0211512 A1
(43) Pub. Date: Jul. 31, 2014

(54) SPLIT PHASE SYNCHRONIZATION OF WELDER/CUTTER INVERTER MODULES FOR RIPPLE IMPROVEMENT

(71) Applicant: Thermal Dynamics Corporation, West Lebanon, NH (US)

(72) Inventors: Steven W. Norris, New London, NH (US); Roger M. Chamberlin, Grantham, NH (US); Michael Sawchik, Charlestown, NH (US)

(73) Assignee: Thermal Dynamics Corporation, West Lebanon, NH (US)

(21) Appl. No.: 14/167,541

(22) Filed: Jan. 29, 2014

Related U.S. Application Data
(60) Provisional application No. 61/759,077, filed on Jan. 31, 2013.

(51) Int. Cl. H02M 1/14; H02M 3/22

(52) U.S. Cl. CPC H02M 1/14; H02M 3/22
USPC 363/15

(57) ABSTRACT

A modular power supply is provided. The modular power supply includes multiple inverters and a controller. Each inverter is configured to receive an input voltage and provide an output to a load. The controller is configured to provide a synchronization signal to each inverter of the plurality of inverters.

### CROSS-REFERENCE TO RELATED APPLICATIONS

This application claims the benefit of provisional application No. 61/759,077, filed on Jan. 31, 2013. The disclosure of the above application is incorporated herein by reference.

### FIELD

The present application generally relates to a modular power supply.

### BACKGROUND

In known multiple inverter welding/cutting power supplies, either the individual inverter modules work individually at their own various switching frequencies, or they are made to operate in synchronization with one of the modules (MASTER), or with an externally supplied SYNC signal.

In the case where no synchronization is used, since the modules are free to operate at different frequencies, the ripple may at one moment be very high, and at the next, be very low. This happens because with the ripple frequency of each individual parallel module being independent of the others, at any moment, the ripple of one module may add to or cancel another module's ripple. In order that the worst case ripple, where the individual inverter ripples add, be less than the specified value of ripple current, the output inductors must be large, to keep the total ripple below the specified amount.

In the case where a SYNC signal is fed to the individual modules, or they are connected so as to synchronize together, the ripple is additive, since all the modules are switching on at the same time. Thus, the output inductors must be large to keep the total output ripple less than that specified.

### SUMMARY

The various implementations described in the present application include a modular power supply. The modular power supply includes multiple inverters and a controller. Each inverter is configured to receive an input power and provide an output to a load. The controller is configured to provide a synchronization signal to each inverter of the plurality of inverters.

In one form, a modular power supply is provided that comprises a first module including a first converter and a first inverter, the first converter providing a first converter output to the first inverter, a second module including a second converter and a second inverter, the second converter providing a second converter output to the second inverter, and a controller providing a first synchronization signal to the first inverter and a second synchronization signal to the second inverter.

In another form, a modular power supply is provided that comprises a plurality of inverters configured to receive an input voltage and provide an output to a load, and a controller providing a synchronization signal to each inverter of the plurality of inverters, the controller determining a phase of each inverter such that each phase is equally spaced throughout a cycle.

Further objects, features and advantages of the described system will become readily apparent to persons skilled in the art after a review of the following description, with reference to the drawings and claims that are appended to and form a part of this specification.

### BRIEF DESCRIPTION OF THE DRAWINGS

FIG. 1 is a schematic illustration of one implementation of a modular power supply;

FIG. 2 is a graphical illustration of resultant ripple for the power supply of FIG. 1;

FIG. 3 is a schematic illustration of one implementation of another modular power supply;

FIG. 4 is a graphical illustration of resultant ripple for the power supply of FIG. 3;

FIG. 5 is a schematic illustration of one implementation of yet another modular power supply;

FIG. 6 is a schematic illustration of one implementation of welding system for implementing the modular power supply; and

FIG. 7 is a schematic illustration of one implementation of a controller.

### DETAILED DESCRIPTION

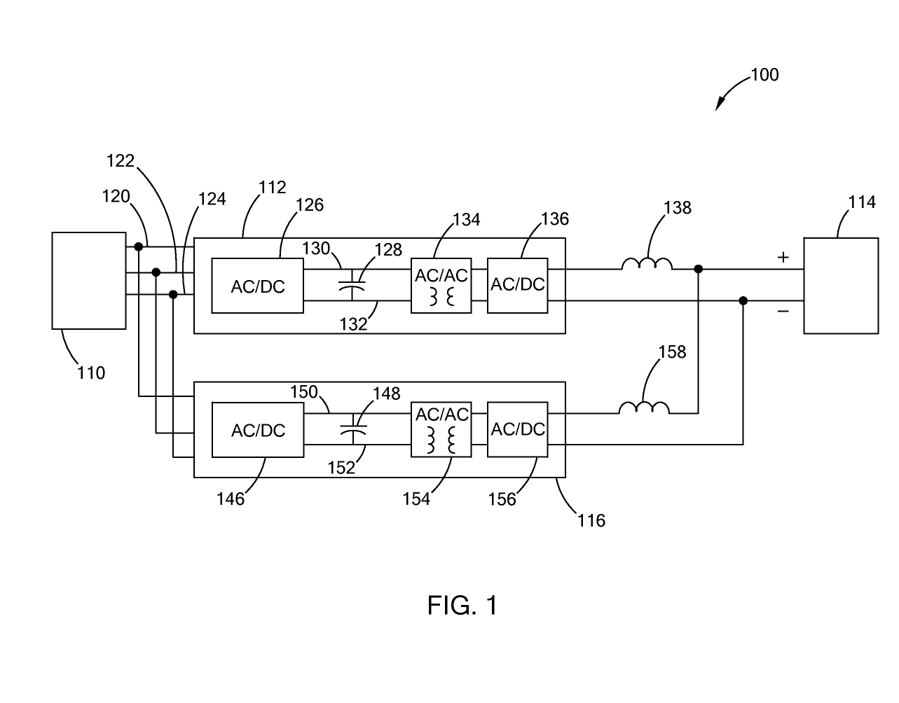

The modules of a modular power system can be configured with their outputs in parallel, and may be controlled for such parameters as ON/OFF and output current, as a group or individually, by a control circuit. These modules can include high frequency switching inverters, thus the inverters may emit electromagnetic noise (EMI) which can cause other circuits, including other of the modules to not work correctly. The modules can be configured to all switch independently, similar to FIG. 1. In this case, the modules should be hardened to the EMI of the other modules so that they continue to perform properly. Alternatively, the modules can be synchronized together or supplied a synchronization signal, such that the modules switch on together or at defined offsets. This can help contain the EMI, such that the modules work well together.

Since each module has an individual output inductor, or in some cases a system may have one inductor for multiple modules, the output ripple current may be dependent on the phasing of the switching cycles of the modules. When the inverter switches are on, the current in an individual module can be increased by a small amount, possibly as high as 10-15% of the module's output current. If there is no synchronization between modules, instance will occur when all or most of the switches in all the modules happen to be on at the same time. During this period of time, the total output current is increased rapidly. As the modules turn off individually, the output current decreases. At another moment in time, perhaps half of the inverter switches are on, and half off, so that the total current is not increasing or decreasing, since the output current provided to the load is the sum of all the individual module output currents. From this scenario, it is easy to see that the current ripple in an unsynchronized system will be random, high one moment and low the next. In order to keep the ripple below some specified value, each individual output inductor must be large enough, so that when all the individual ripple currents add together, the total is less than the maximum rated ripple specification.

As used throughout, the terms “first” and “second” when referring to the output of a particular component or module should be understood to also mean the “positive” and “negative” outputs, respectively, unless otherwise indicated.

FIG. 1 is one embodiment of a modular power system 100 where the inverters are unsynchronized. The system 100 includes a power source 110. The power source 110 may be a three phase power source, for example supplying three phase AC voltage to a first module 112 and a second module 116. The output of the first module 112 and second module 116 are then provided to load 114 such as a welding or plasma cutting unit. Accordingly, the first input 120, second input 122, and the third input 124 from the power source 110 are provided to both the first module 112 and the second module 116.

In the first module 112, the power inputs are received by an AC/DC convertor 126. The AC to DC convertor 126 has a positive output 130 and a negative output 132. A capacitance 128 may be provided between the positive output 130 and the negative output 132 to stabilize the output. The positive output 130 and the negative output 132 are provided to an inverter 134. The output of the inverter 134 is then provided to an AC to DC converter 136. The positive output of the converter 136 may be connected to an inductor 138 that is in series with the load 114. Although in some implementations, the negative output(s) may be connected to an inductor that is in series with the load.

The second module 116 also receives the three phase inputs 120, 122, 124 from the power source 110. The inputs are processed by an AC to DC convertor 146 to generate a positive output 150 and a negative output 152 and capacitance 148 is connected between the positive output 150 and negative output 152 to stabilize the output signal. The positive output and negative output are provided to an inverter 154. The output of the inverter 154 is then provided to an AC to DC converter 156. The positive output of the converter 156 may be connected to an inductor 158 that is in series with the load 114. Although in some implementations, the negative output(s) may be connected to an inductor that is in series with the load.

Further, the output of the second module 116 connected through inductor 158 to the load 114 is in electrical parallel connection to the output of the first module 112 to the load 114 through inductor 138. In addition, the second output of the inverter 154 is connected to the second output of the first module 112 and to the load 114. Accordingly, the inverter 134 of the first module 112 is not synchronized to the inverter 154 of the second module 116.

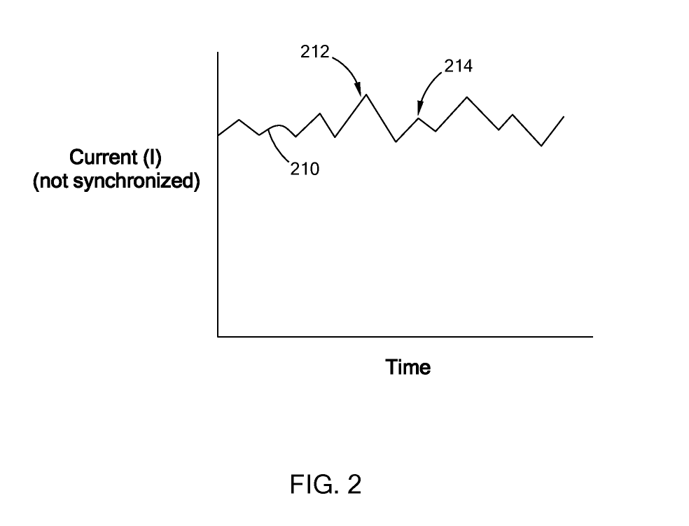

Referring to FIG. 2, the current output to the load 114 is illustrated by line 210. Since the current is not synchronized between the two inverters, the ripple of the current signal will vary, as illustrated by peak 212 which is much larger than peak 214.

When the modules are synchronized such that the switches all turn on together, the ripple current is repeatable, but at its maximum. Each module is increasing the output current at the same time, and then decreasing at the same time. Again, even though this gives a repeatable total ripple current, the output inductors must be sized such that the total ripple current is below the specified maximum.

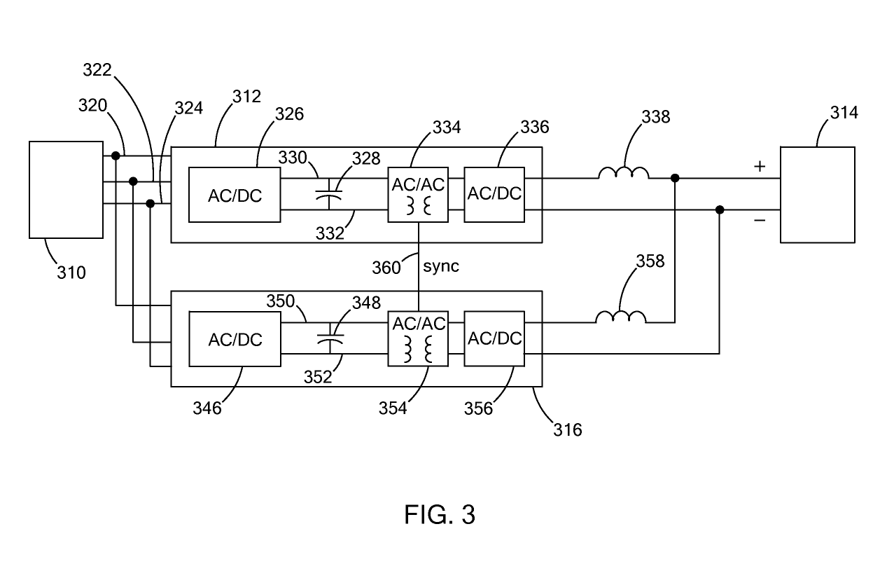

FIG. 3 is one embodiment of a module power system 300 where the inverters are synchronized. The system 300 includes a power source 310. The power source 310 may be a three phase power source, for example supplying three phase AC voltage to a first module 312 and a second module 316. The output of the first module 312 and second module 316 are then provided to load 314 such as a welding or plasma cutting unit. Accordingly, the first input 320, the second input 322, and the third input 324 from the power source 310 are provided to both the first module 312 and the second module 316.

In the first module 312, the power inputs are received by an AC/DC convertor 326. The AC to DC convertor 326 has a positive output 330 and a negative output 332. A capacitance 328 may be provided between the positive output 330 and the negative output 332 to stabilize the output signal. The positive output 330 and the negative output 332 are provided to an inverter 334. The output of the inverter 334 is then provided to an AC to DC converter 336. The positive output of the converter 336 may be connected to an inductor 338 that is in series with the load 314. Although in some implementations, the negative output(s) may be connected to an inductor that is in series with the load.

The second module 316 also receives the three phase inputs 320, 322, 324 from the power source 310. The inputs are processed by an AC to DC convertor 346 to generate a positive output 350 and a negative output 352 and capacitance 348 is connected between the positive output 350 and negative output 352 to stabilize the output signal. The positive output and negative output are provided to an inverter 354. The inverter 354 is synchronized with inverter 334, through a synchronization signal as denoted by line 360. As such, the inverter 354 may adjust the timing of the switches within the inverter based on the synchronization signal such that a phase delay is created between the output of the inverter 354 with respect to inverter 334. The output of inverter 354 is provided to converter 356. The first output of the converter 356 is connected to the load 314 through an inductor 358. Although in some implementations, the negative output(s) may be connected to an inductor that is in series with the load.

Further, the first output of the second module 316 connected through inductor 358 is in electrical parallel connection to the first output of the first module 312 through inductor 338. In addition, the second output of the second module 316 is connected to the second output of the first module 312 and to the load 314.

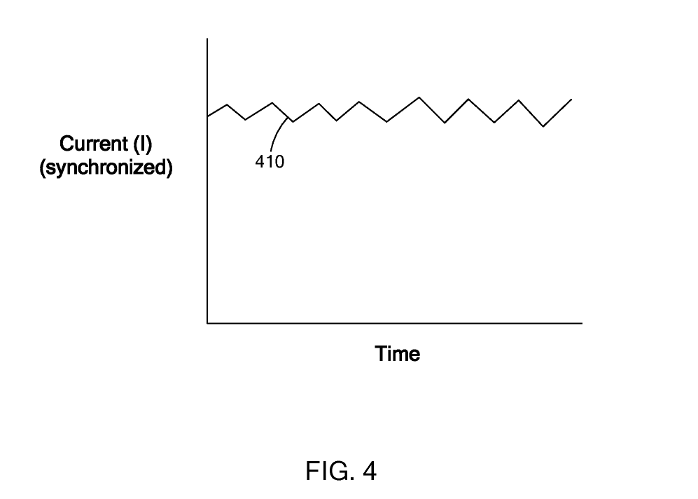

Now referring to FIG. 4, the current of the system of FIG. 3 is illustrated by line 410. As can be noted, the ripples on the synchronized current are consistent and do not vary significantly with respect to time.

In another embodiment the inverters can be synchronized and offset. As such, the phase shift of each inverter can be selected so that when one inverter module has its switches on and is increasing the output current, other inverters are off, and decreasing their individual currents. However practically implementing such control is difficult. The system may need to determine how many modules are present, and be able to deliver the correctly spaced synchronization signals to each module to turn on its switches at the right time.

With the prevalence of microprocessor based control circuits, synchronization may be implemented in software. The microprocessor can determine how many modules are present and can generate the appropriate synchronization signals. For one module, the synchronization signal may be placed at 0° and 180° phase shifts at a frequency twice the switching frequency, since most inverters are push-pull and have 2 output pulses per switching cycle. If there are two modules present, the first module may receive a synchronization signal at 0° and 180°, and the second module may receive synchronization signals at 90° and 270°. If there are three modules present, the first module may receive a synchronization signal at 0° and 180°, the second module may receive a synchronization signal at 60° and 240°, and the third module may receive a synchronization signal at 120° and 300°. In this way, the output current ripple is at a minimum for whatever number of modules is present, and the implementation may be accomplished via software control, and a local pulse shaper at each module which takes the microprocessor signal and turns it into a usable signal for the pulse-width modulator control IC in the module.

The advantage of this type of synchronization is that the size of the output inductor of each module can be minimized (in cost, size, and weight) given the acceptable maximum ripple current per the specification.

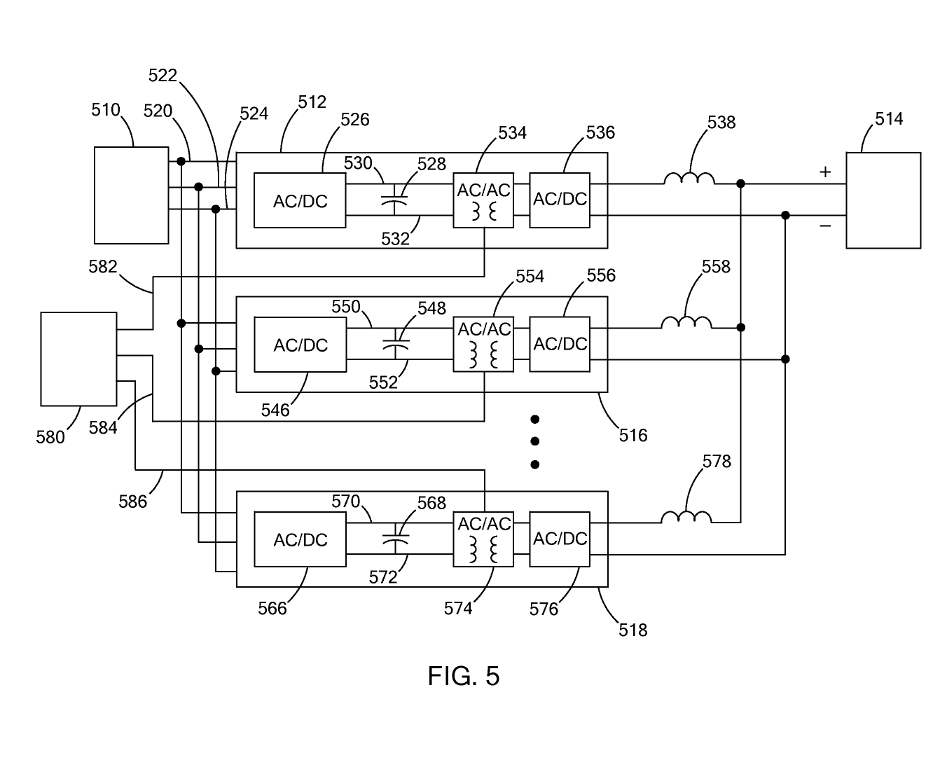

FIG. 5 is one embodiment of a modular power system 500. The system 500 includes a power source 510. The power source 510 may be a three phase power source, for example supplying three phase AC voltage to a first module 512, a second module 516, and a third module 518. The output of the first module 512, the second module 516, and the third module 518 are then provided to load 514, such as a welding or plasma cutting unit. Accordingly, the first input 520, second input 522, and the third input 524 from the power source 510 are provided to each of the first module 512, the second module 516, and the third module 518.

In the first module 512, the power inputs are received by an AC/DC convertor 526. The AC to DC convertor 526 has a positive output 530 and a negative output 532. A capacitance 528 may be provided between the positive output 530 and the negative output 532 to stabilize the output signal. The positive output 530 and the negative output 532 are provided to an inverter 534. The output of the inverter 534 is then provided to an AC to DC converter 536. The positive output of the converter 536 may be connected to an inductor 538 that is in series with the load 514.

The second module 516 also receives the three phase inputs 520, 522, 524 from the power source 510. The inputs are processed by an AC to DC convertor 546 to generate a positive output 550 and a negative output 552 and capacitance 548 is connected between the positive output 550 and negative output 552 to stabilize the output signal. The positive output and negative output are provided to an inverter 554. The output of the inverter 554 is then provided to an AC to DC converter 556. The positive output of the converter 556 may be connected to an inductor 558 that is in series with the load 514. Further, the first output of the first module 512 connected through inductor 538 is an electrical parallel connection to the first output of the second module through inductor 558. In addition, the second output of the second module 516 is connected to the second output of the first module 512 and to the load 514.

The third module 518 also receives the three phase inputs 520, 522, 524 from the power source 510. The inputs are processed by an AC to DC convertor 566 to generate a positive output 570 and a negative output 572 and capacitance 568 is connected between the positive output 570 and negative output 572 to stabilize the output signal. The positive output and negative output are provided to an inverter 574. The first output of the third module 518 is connected to the load 514 through an inductor 578. Further, the first output of the third module 518 connected through inductor 578 is an electrical parallel connection to the first output of the first module 512 through inductor 538. In addition, the second output of the third module 518 is connected to the second output of the first module 512 and to the load 514.

The system also includes a controller 580. The controller 580 provides a synchronization signal to each inverter. As such, the controller 580 provides a first synchronization signal 582 to inverter 534 of the first module 512. Similarly, the controller 580 provides a synchronization signal 584 to the inverter 554 of the second module 516 and a synchronization signal 586 to the inverter 575 of the third module 518.

In addition, it is understood that multiple additional inverters may be used along with additional synchronization signals being provided to each inverter of each additional module. The synchronization signals may be evenly spread over a 360 degree cycle such that the ripple current of each module is non-additive in conjunction with the other modules. Further, the ripple frequency may be two (2) times the number of modules times the base switching frequency. This allows the use of smaller less expensive inductors for each output module.

In one specific embodiment the microcontroller may be programmed to count the number X of modules in the system, and put out X signals, each of which is phased 180/X degrees from each other. In the case of a single pulse inverter, the signals would be 360/X degrees from each other. In the case of a double pulse inverter, the signals would be 180/X degrees from each other. As such, a generalized phase spacing between the inverters could be calculated as:

spacing=360°/(number of inverter pulses per cycle*number of inverters) (1)

By doing this, each inverter's individual ripple is adding to the total ripple out of phase with all the other inverters, and the total ripple will be minimized, e.g. when the ripple in one module is increasing, it is decreasing in others, so that the total ripple excursion is minimized.

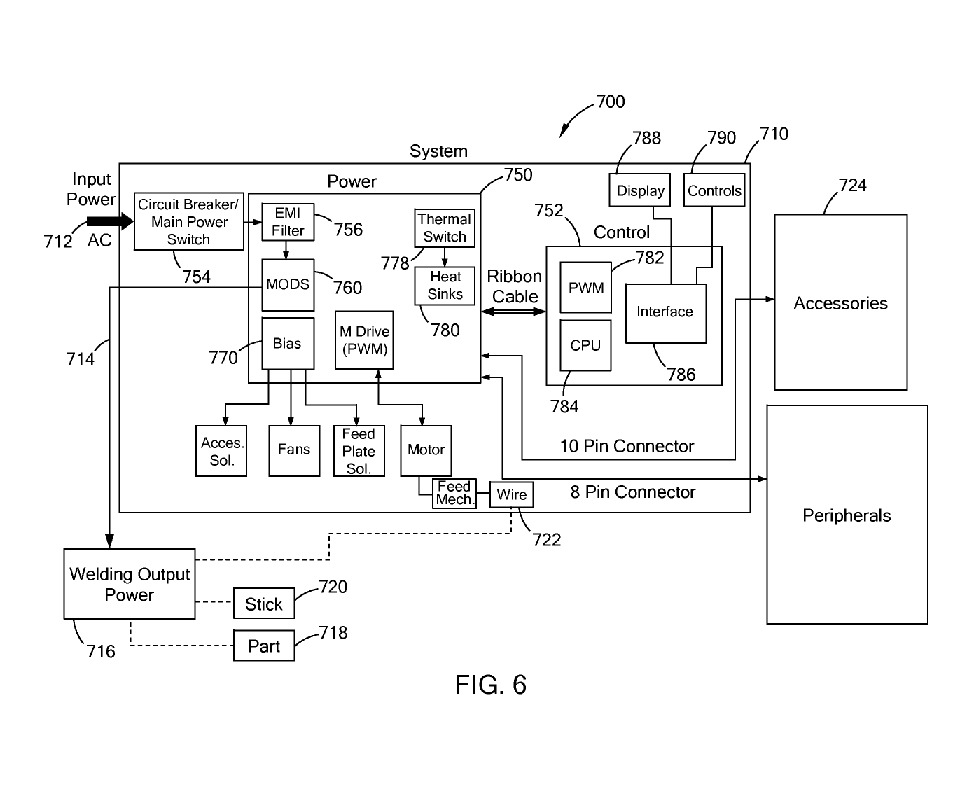

Now referring to FIG. 6, any of the power supply components described above may be implemented in a welding system 700 as provided. The power supply 710 receives input power 712 which may be a three phase alternating current power line. In some implementations, the power supply 710 may be used for stick welding (also known as Shielded Metal Arc Welding or SMAW) or various other welding applications such as MIG (Metal Inert Gas, also known as gas metal arc welding or GMAW), flux core arc welding, TIG (tungsten inert gas welding, also known as Gas Tungsten Arc Welding or GTAW), plasma arc, or other welding techniques. Therefore, in one example the current return lead of the welding output power 716 may be provided to a part 718 that is to be welded, and the supply voltage may be provided to an electrode, for example a stick 720 or wire 722. Therefore, as the stick 720 comes in contact with the part 718 an arc may be formed that melts both the base metal and electrode and cooperates to form a weld. In other implementations, the output voltage may be provided through a wire 722 where the wire 722 may be continuously fed to the part to form a continuous weld. In TIG mode the electrode is not melted, generally only the base metal is melted.

The power supply 710 may control the output voltage and the output current, as well as the feeding of the wire to optimize the welding process. In addition, the power supply 710 may be connected to a group of accessories 724.

Within the power supply 710, the input power 712 may be provided to a circuit breaker or switch 754. Power may be provided from the circuit breaker 754 to a power circuit 750. The power circuit 750 may condition the input power to provide a welding output power 716, as well as, for powering various additional accessories to support the welding process. The power circuit 750 may also be in communication with the control circuit 752. The control circuit 752 may allow the user to control various welding parameters, as well as, providing various control signals to the power circuit 750 to control various aspects of the welding process. The power from the circuit breaker 754 may be provided to an EMI filter 756 of the power circuit 750. Power is provided from the EMI filter 756 to the power supply modules 760 as described elsewhere in this application. The power supply modules may provide the welding output power 716.

Power may also be provided to a bias circuit 770 to power a number of accessories internal or external to the power supply 710 that facilitate operation of the power supply, as well as, the welding process. The control circuit 752 may provide control signals to any of the previously mentioned circuits in the power circuit 750 to optimize the weld process and performance of the power supply 710.

The control circuit 752 may include a pulse width modulator 782 and a processor 784 for analyzing various weld characteristics and calculating various weld parameters according to user settings, as well as, various feedback signals. In addition, an interface circuit 786 may be provided to control a display 788 that may provide information to the user of the welding system. The controls 790 may also be in communication with the interface circuit 786 to allow the user to provide input such as various welding parameters to control the operation of the welding process.

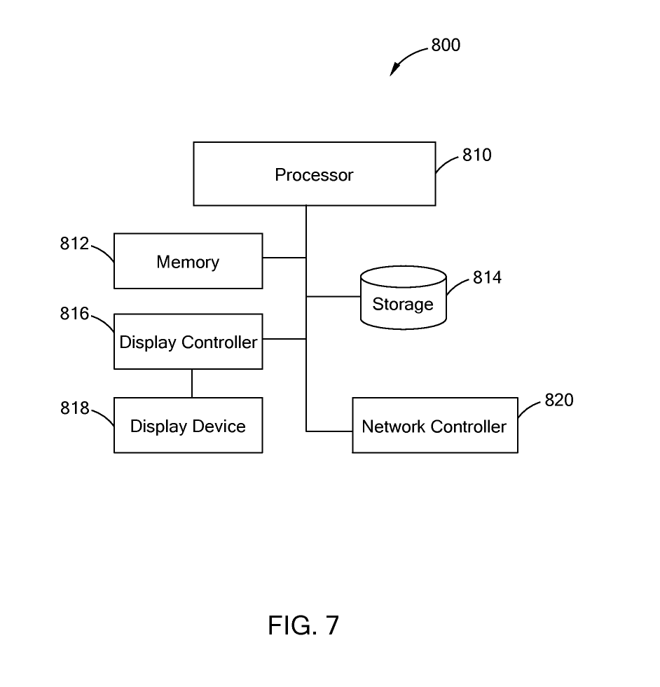

Any of the controllers, modules, servers, or engines described may be implemented in one or more computer systems. One exemplary system is provided in FIG. 7. The computer system 800 includes a processor 810 for executing instructions such as those described in the methods discussed above. The instructions may be stored in a computer readable medium such as memory 812 or storage devices 814, for example a disk drive, CD, or DVD. The computer may include a display controller 816 responsive to instructions to generate a textual or graphical display on a display device 818, for example a computer monitor. In addition, the processor 810 may communicate with a network controller 820 to communicate data or instructions to other systems, for example other general computer systems. The network controller 820 may communicate over Ethernet or other known protocols to distribute processing or provide remote access to information over a variety of network topologies, including local area networks, wide area networks, the Internet, or other commonly used network topologies.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of the application. This description is not intended to limit the scope or application of the invention in that the invention is susceptible to modification, variation and change, without departing from spirit of the invention, as defined in the following claims.

What is claimed is:

1. A modular power supply comprising:
a first module including a first converter and a first inverter, the first converter providing a first converter output to the first inverter;
a second module including a second converter and a second inverter, the second converter providing a second converter output to the second inverter; and
a controller providing a first synchronization signal to the first inverter and a second synchronization signal to the second inverter.

2. The power supply according to claim 1, wherein the controller synchronizes the first inverter to be a specified number of degrees out of phase with the second inverter.

3. The power supply according to claim 1, wherein the first module includes a first capacitance between a positive line and a negative line of the first converter output.

4. The power supply according to claim 1, wherein the first module includes a third converter and the second module includes a fourth converter.

5. The power supply according to claim 1, wherein the first converter is an AC to DC converter.

6. The power supply according to claim 1, wherein the first module is connected to a load through a first inductor.

7. The power supply according to claim 1, wherein the second module is connected to a load through a second inductor.

8. The power supply according to claim 1, wherein the first and second inductors are in a parallel electrical connection.

9. A modular power supply comprising:
a plurality of inverters configured to receive an input voltage and provide an output to a load; and
a controller providing a synchronization signal to each inverter of the plurality of inverters, the controller determining a phase of each inverter such that each phase is equally spaced throughout a cycle.

10. The power supply according to claim 9, wherein the inverter phase spacing is defined by:
phase spacing=360°/(number of inverter pulses per cycle*number of inverters).

11. The power supply according to claim 9, wherein each inverter is configured to receive the input voltage from a corresponding first converter, a capacitance being connected between a positive input line and a negative input line of the inverter.

12. The power supply according to claim 11, wherein each inverter is configured to provide an output voltage to a corresponding second converter.

13. The power supply according to claim 12, wherein each second converter is configured to provide a voltage to a load in parallel.

14. The power supply according to claim 13, wherein each second converter is configured to provide a voltage to a load through a corresponding inductor.

15. The power supply according to claim 12, wherein the first converter is an AC to DC converter.

16. The power supply according to claim 15, wherein the second converter is an AC to DC converter.
